(19) United States
(12) Patent Application Publication
(10) Pub. No.: US 2003/0106969 A1
(43) Pub. Date: Jun. 12, 2003

(54) Blood pack suspension means

(76) Inventors: Jagmohanbir Singh Dillon, Oxley (AU); Christopher Allen Patton, Olney, MD (US); William Leonard Mobbs, Farrar (AU)

Correspondence Address: Sidley Austin Brown & Wood, 1501 K Street NW, Washington, DC, 20005, US

(21) Appl. No.: 10/332,822

(22) PCT Filed: Jul. 13, 2001
(86) PCT No.: PCT/AU01/00846

(51) Int. Cl. F16M 11/00; A47K 1/04

(52) U.S. Cl. 248/157; 248/129

(57) ABSTRACT

Apparatus for suspending full blood packs to assist filtration or leucodepletion is disclosed. In one embodiment (FIG. 4) it takes the form of a trolley or cart (40) having a rectangular rack (44) fitted with hooks (46) for suspending blood packs (not shown), and a tray-like platform (48) adapted to receive and support the receiving bags of the packs. Actuator means in the form of an air-ram (with piston 62) is employed to raise and lower the rack (44) and actuator means in the form of a pistonless air-ram (79) is used to independently raise and lower the platform (48). The actuator means are powered by a gas reservoir in a central casing (80) and suitable controls. In use, the platform (48) is raised to a convenient height for an operator to load blood-receiving bags thereon and the rack (44) is lowered to a convenient height for the operator to hook the full blood bags onto the hooks (46). The platform (48) is then lowered and the rack (44) is raised until the vertical distance between them is that recommended by the filter manufacturer. After, drainage of the blood bags, the rack (44) is lowered and the platform (48) is raised to permit the operator to seal the receiving bags, separate them from the blood bags and filters and unload the cart (40).

### TECHNICAL FIELD

This invention relates to apparatus and methods for use in suspending blood packs after blood collection to assist filtration or leucodepletion.

### BACKGROUND

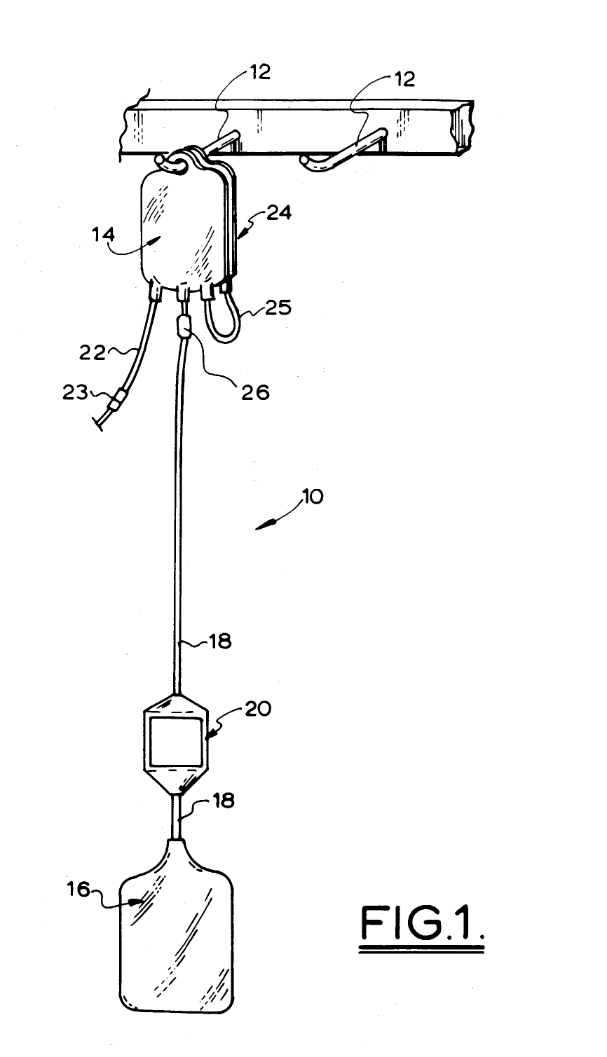

The filtration of leucocytes from collected blood—called leucodepletion—is now preferred in blood collection procedures in many developed countries. In one common method, illustrated in FIG. 1, a normal three-bag collection set 10 is suspended from a wall-mounted hook 12 so that blood can drain from the collection bag 14 into a receiving bag 16 via a transfer line 18 and an in-line filter 20. The blood collection procedure is normal in that blood is drawn from the vein of a patient via a needle line 22 connected to collection bag 14. After sufficient blood has been collected, line 22 is cut and sealed with a clip 23 so that the needle (not shown) can be removed and disposed of. Blood in bag 14 is then displaced into a second bag 24 via a connecting tube 25, bag 24 containing anticoagulant and/or preservative solutions. The blood mixture is then returned to bag 14. Bags 14 and 24 are then suspended by hook 12 and a frangible seal 26 in line 18 is broken to allow fluid (principally blood) to flow from bags 14 and 14 into receiving bag 16 via the leukocyte filter 20. After sufficient blood has drained into bag 16, line 18 is sealed with clips (not shown) between filter 20 and receiving bag 16. Receiving bag 16 is then removed for storage, leaving the rest of the collection set free for appropriate waste disposal.

It will be appreciated that bags 14 and 24 as shown in FIG. 1 may be effectively interchanged. That is bag 24 may receive blood from the donor, line 22 being connected to bag 24 rather than bag 14, and bag 14 may contain the anticoagulant or preservative solution. Thus, after transfer of the collected blood from bag 24 to bag 14, the mixture can flow down line 18 without the need for re-transfer into the collection bag.

The vertical distance—or head—between collection bag 14 and receiving bag 16 should be set according to the recommendation of the filter manufacturer. It normally ranges between 1.5 and 2 meters. Ideally, the length of the transfer tube should correspond to this recommendation so that a set suspended as shown in FIG. 1 will automatically have the recommended head. However, this is not always the case as manufacturers of bag-sets use filters from different suppliers and prefer to make the transfer line a fixed length that corresponds to the largest head of the available filters. The duration of the filtration process and the temperature at which it is carried out are normally parameters set by the collection agency.

During the final stages of blood filtration, it is sometimes necessary for blood-bank staff to manipulate the receiving bag 16 to remove air pockets and permit proper filling of the bag. This procedure is sometimes called ‘burping’.

Although the suspension of bag sets and the filtration process described is simple and straight forward, it is poorly suited to processing hundreds of bags in a day. The racks of hooks 12 are generally wall mounted, so that the bags must be carried to and from the walls, which can cause access congestion and confusion. Each bag set must be suspended from a hook 12 that is higher than the head of most staff and burping of the receiving bag 16 must be done at below knee level, requiring staff to stoop, squat or bend. Moreover, if the head as determined by the length of the transfer tube 18 is greater than that recommended by the filter supplier, the receiving bags need to be supported in some manner.

### OUTLINE OF THE INVENTION

From one aspect, the present invention comprises apparatus for suspending blood packs while blood therein is drained under gravity via transfer lines into respective receiving packs through respective in-line filters, the apparatus comprising:

first support means adapted to support blood collection bags during the transfer of blood therefrom,

second support means adapted to support receiving bags,

means for independently raising and lowering said first and second support means so that (a) the first and second support means can be placed at a convenient height for the attachment of the collection bags, (b) the vertical distance between the first and second support means can be set to the head appropriate for the filters of the bag sets, and (c) the second support means can be placed at a convenient height for the handling of the receiving bags.

The first support means may be a rack of hooks or forks that can be arranged in a circular, rectangular or polygonal shape. The second support means may be a platform—preferably tray-like—upon which the receiving bags can be supported. If desired, the platform may be divided into compartments to take one or more receiving bags each. The support means may be mounted on a trolley-like base so that the apparatus can be wheeled into a location convenient for loading, timed filtration and unloading.

It is desirable that, where the second support means is tray like, it be removable from the apparatus or trolley for cleaning purposes as it is possible for blood to spill from a damaged bag or line into the second support means. Conveniently, the second support means comprises two C-shape sub-trays that can be joined together to form an annulus within which the receiving bags are supported. As indicated above, the sub-trays can be divided into compartments to take individual receiving bags or to take a few bags each. Coupling means may be provided to hold the C-shape sub-trays together when in use and to allow them to be separated and removed for cleaning when not in use. The sub-trays conveniently slide on guide means for this purpose. The central portion of the annulus formed by the two sub-trays can accommodate the means for independently raising and lowering the rack and platform.

The means for independently raising and lowering the rack and platform may be any convenient actuator or actuators, but it preferably includes vertical linear actuator means that it is self-contained so that it can be mounted on the trolley-like base and moved with it. For example, separate battery-operated linear-actuators can be employed for the rack and platform, the required battery being supported by the base. Alternatively, the raising and lowering means can be chain or pulley hoists operated by battery driven electric motors. Alternatively again, the raising and lowering means may comprise hydraulic or pneumatic cylinders supplied by electric pumps or by a compressed gas reservoir. While a self-contained system is preferred, the use of an external electric or gas supply is also envisaged, though it requires additional connection and disconnection procedures and limits the mobility of portable apparatus. Of course, a self-contained unit will need to be periodically recharged by external means from time to time, though it will not require external connection once it has been charged. It is also envisaged that the raising and lowering means may be hand-powered—for example by the use of cranks and pulleys—though this is not preferable given the busy environment of typical blood collection centers.

We have found it preferable, in a self-contained wheeled unit, to employ one gas-operated ram to raise and lower the rack and another to raise and lower the platform, both rams being powered from a pressurized on-board reservoir through separate manual controls. Conveniently, both the rack and the platform may be guided for vertical movement by a pair of parallel vertical posts so that the rack may be raised and lowered by the piston of a conventional ram that is arranged centrally between the posts, and so that the platform may be raised and lowered by a rod-less piston having an actuator pin that extends transversely from the side of the piston. The rod-less piston is preferably hollow and mounted in or forms part of one of the posts. Of course, pistons with normally arranged rods may also be employed.

An indicator to display may be included in the apparatus so as to indicate the vertical distance or head between the rack and platform when the unit is in use. For simplicity, the indicator readout assumes that the platform is at its lowermost level.

From another aspect, the invention comprises a method of handling sealed blood packs after blood collection, each pack including at least a first bag containing blood, a second bag for receiving blood, a tube interconnecting said bags and a filter arranged or connected in the tube so that blood flowing in the tube from the blood containing bag to the blood receiving bag passes through the filter, the method comprising the steps of:

suspending the blood containing bags of a plurality of packs from a rack so that their tubes hang down therefrom,

supporting the blood receiving bags of said packs below their respective blood containing bags,

lowering the platform and the blood receiving bags supported thereon, and

raising the rack and the blood containing bags suspended therefrom.

The method will normally include one or more of the following additional steps:

enabling blood to flow through the tube after the blood-containing bags have been suspended,

raising the platform after blood has been transferred to the receiving bags,

manipulating the receiving bags to release gas therefrom,

sealing the tube of each pack between the filter and the receiving bag,

severing the tube,

removing the receiving bags from the platform,

lowering the rack, and

removing the first bags, filters and remaining tubes from the rack.

It will be appreciated that many different types of apparatus and methods can be used to implement the principles outline above. Such methods and apparatus are within the scope of the present invention.

For example, the upper rack or support means can be used to mount or suspend heat-sealing means for use in sealing the blood lines. The heat-sealing means can be one or more fixed or hand-held electrical heat-sealers and/or line cutters removably mounted on the rack or support means at one or more convenient locations. If the heat-sealing means is fixed it is preferably located in a position or positions where blood lines to be sealed and/or severed can be conveniently placed within its jaws. If the heat-sealing means is portable it can be battery powered and self-contained or cord powered, but in either case, it should again be mounted conveniently for use.

### DESCRIPTION OF EXAMPLES

Having broadly portrayed the nature of the present invention, an example will now be described with reference to the accompanying drawings, in which:

FIG. 1 is a diagram showing a blood pack arranged in the conventional manner to effect blood filtration.

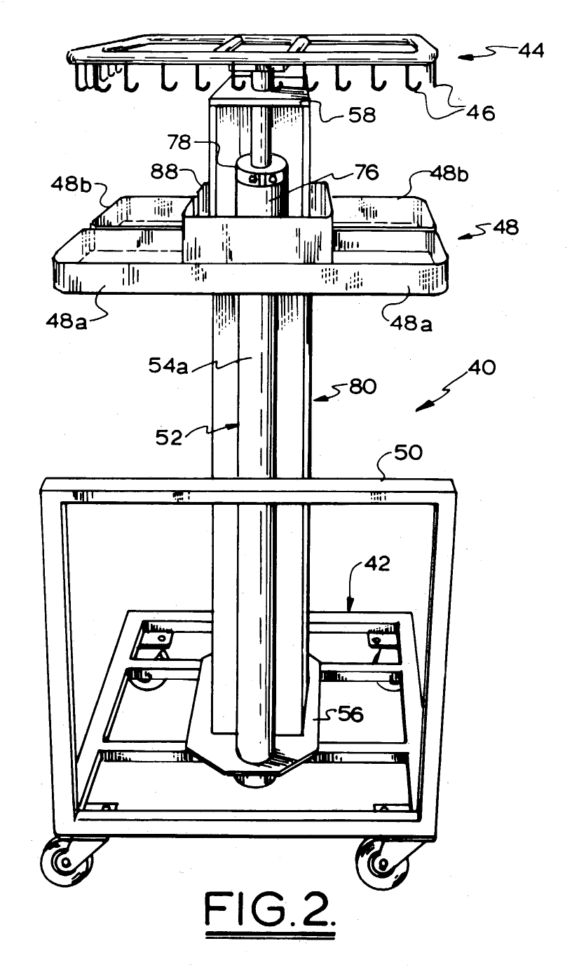

FIG. 2 is a front perspective view of the blood pack trolley of the chosen example with the platform raised and the rack lowered.

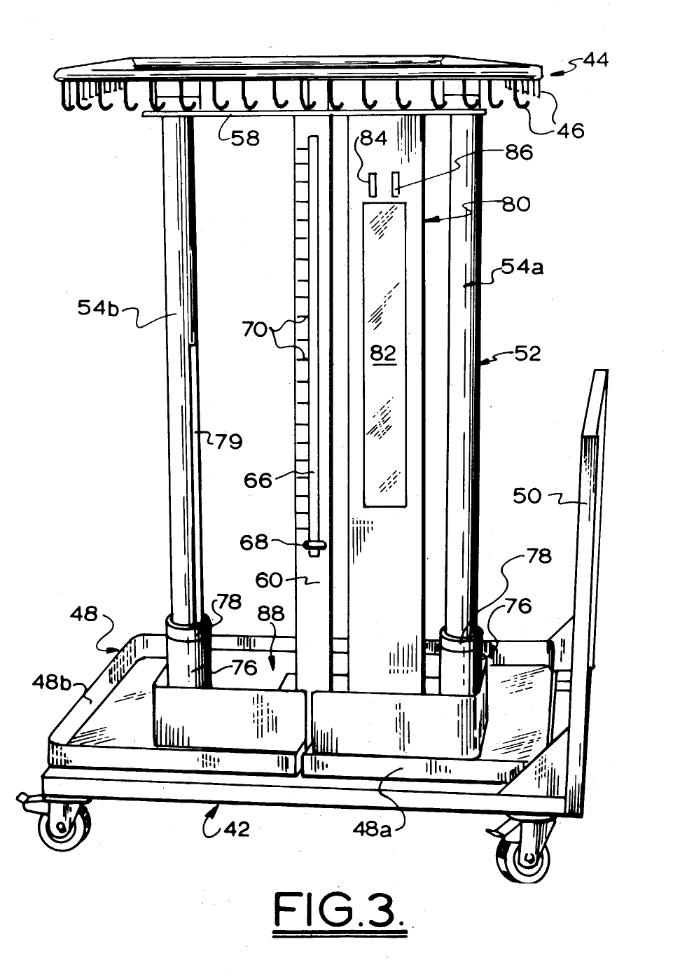

FIG. 3 is a side perspective view of the trolley of FIG. 2 with both the platform and the rack lowered.

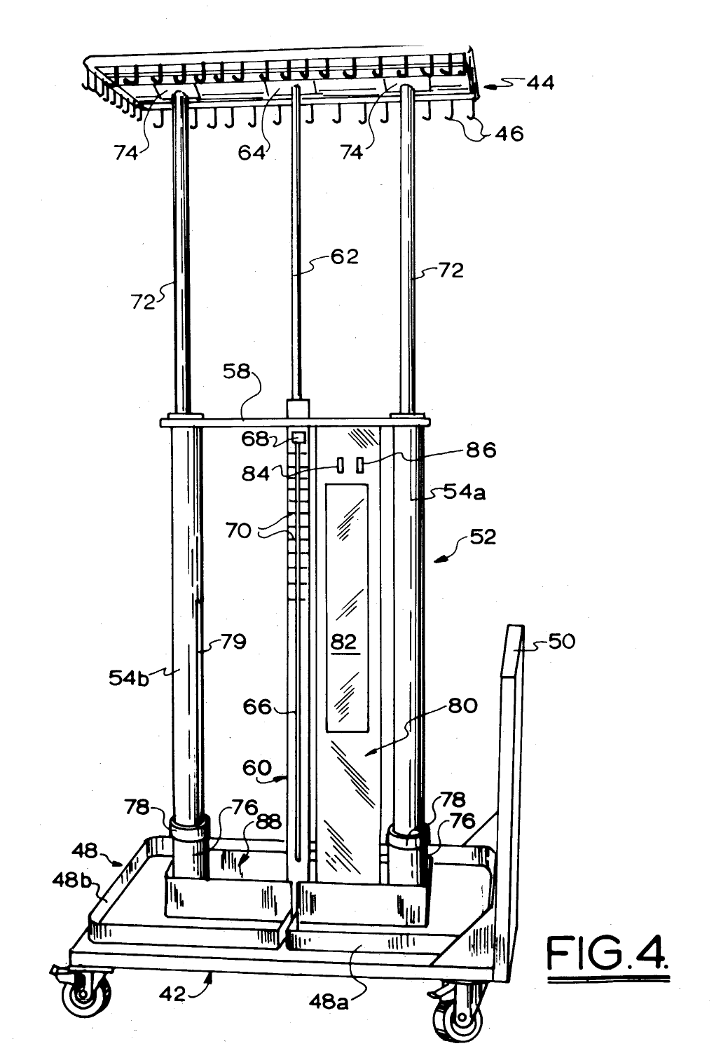

FIG. 4 is a side perspective view of the trolley of FIG. 2 with the platform lowered and the rack raised.

The conventional way of effecting filtration of blood in blood packs has already been described above with reference to FIG. 1. For the sake of drawing clarity, the blood packs will not be shown in FIGS. 2 to 4, since exactly the same packs can be employed with the trolley of the chosen example.

Referring generally to FIGS. 2 to 4, the chosen example comprises a blood pack trolley or cart 40 having a wheeled base 42, a rectangular rack 44 fitted with peripheral hooks 46 for suspending blood packs, and a tray-like platform 48 adapted to receive and support the receiving bags of the packs. Thus, in this example, the aforesaid first support means comprises rack 44 and the aforesaid second support means comprises platform 48. Tray-like platform 48 is formed by two mating C-shape halves 48a and 48b that are preferably fastened together by suitable catches or clips (not shown). C-shape halves 48a and 48b are supported on rails or a base (not shown) so that they can be slidingly removed horizontally (when in the raised position) after the catches have been released. This allows the platform to be cleaned in the event of a blood spill. Base 42 has a handle 50 at the front by which cart 40 can be conveniently pushed or pulled along a floor.

A central frame 52, which comprises a pair of vertical hollow cylindrical columns 54a and 54b joined at their lower ends by a bottom plate 56 and at their top ends by a top plate 58, is fixed to base 52. Located centrally between columns 58 is a first vertical casing 60 that houses the cylinder of a pneumatic ram (not shown). The piston 62 of the ram is fixed by a plate 64 (FIG. 4) to the center of rack 44 so that the rack can be raised and lowered by the use of the ram. One side of casing 60 is slotted at 66 to take a sliding indicator 68, which is connected to piston 62 inside casing 60. A scale, indicated at 70 is marked on the slotted side of casing 60 to indicate height (ie, the position of piston 62).

Two cylindrical guide rods 72 are attached to rack 44 by plates 74 (FIG. 4) so as to depend vertically downwards from rack 44 and to enter respective ones of hollow columns 54 for sliding engagement therewith. Guide rods 72 thus serve to align rack 44 with base 42 at all times during its vertical movement.

Cylindrical sleeves 76 are slidingly located about respective ones of columns 54 and affixed to platform 48 so that the platform is kept horizontal and guided for vertical movement by columns 54. A locking collar 78 is attached to the top of each sleeve so that the vertical position of platform 48 can be set by operation of collar 78. A rod-less pneumatic actuator (not shown) is enclosed within column 54b, which has an inwardly facing slot 79 to take the sideways projecting moving tab of the actuator, the tab being secured to the bottom or side of platform 48. [The rod-less actuator and its tab are not visible in the Figures.] By means of the rod-less actuator, platform can be moved up and down under gas pressure.

A second and larger vertical casing 80 is located between columns 54 to one side of first casing 60, casing 80 housing a compressed gas cylinder (not shown). Access to the cylinder for recharging purposes is obtained via a removable or hinged panel 82. First and second control levers 84 and 86 are mounted in the top of casing 80 to effect the actuation of piston 62 and the actuation of the rod-less actuator, respectively. As will be best seen from FIG. 2, a central well 88 is formed in platform 48 between the mating C-shape halves 48a and 48b to accommodate casings 60 and 80.

In use, an empty cart 40 is stored with rack 44 lowered and platform 48 raised and locked as shown in FIG. 2. The unloaded cart is wheeled into the collection room and loaded with blood packs as they are filled. Loading is performed by suspending each blood containing bag on one of hooks 46, placing its connected filter and receiving bag on platform 48 and breaking the frangible seal in the tube of the pack to initiate blood flow to the receiving bag. When sufficient bags have been loaded to make a batch, platform 48 with its load of receiving bags is fully lowered by unlocking rings 78 and operating lever 86. [The configuration of the cart is then as shown in FIG. 3.] Cart 40 is then wheeled into a cool room, or into a room-temperature area, and positioned conveniently. Rack 44 is then raised by operation of lever 84 until (by reference to scale 70 and indicator 68) the head recommended by the manufacturer is reached. [The position of the cart is then as shown in FIG. 4.]

The cart is left in this state for the recommended time before platform 48 is again raised so that the receiving bags can be burped and the tubes sealed and severed to separate the empty blood bags and the associated filters from the receiving bags. The receiving bags can then be removed from platform 48 and rack 44 can then be lowered and all empty blood bags removed from hooks 46 for disposal.

It will be appreciated that the blood pack cart of the example provides a number of important benefits:

The height of hooks 46 can be set or arranged so that people of normal stature will find it comfortable to load the blood packs.

The height of platform 48 can be set or arranged so that people of normal stature will find it comfortable to handle the blood packs.

Platform 48 can be split into to halves to allow read separation and removal for cleaning.

The loaded cart is wheeled when its center of gravity is low so that it is not inclined to tip upon striking an obstacle.

The recommended head can be set correctly according to the filters used in each batch of bags.

Hand-held heat-sealing tools can be readily mounted on the upper rack 44.

There is no need to move a cart with its rack raised.

Burping, line sealing and cutting can all be performed with the bags at a convenient height, preferably using tools mounted on the cart.

Removal or unloading of the bags also can be performed with the bags at a convenient height for the staff employed.

While one example has been described and illustrated, it will be appreciated that many changes to this example can be made without departing from the scope of the present invention as defined by the following claims.

1. Apparatus for suspending blood packs while fluid therein is drained under gravity via transfer lines into respective receiving packs through respective in-line filters, the apparatus comprising:
first support means adapted to support blood collection bags during the transfer of blood therefrom,
second support means adapted to support receiving bags,
actuator means for independently raising and lowering said first and second support means so that (a) the first and second support means can be placed at a convenient height for the attachment of the collection bags, (b) the vertical distance between the first and second support means can be set to the head appropriate for the filters of the bag sets, and (c) the second support means can be raised to a convenient height for the handling of the receiving bags, prior to and after the transfer of blood thereto.

2. Apparatus according to claim 1 wherein:
said first support means comprises a rack of hooks or forks arranged in a circular, rectangular or polygonal shape,
said second support means comprises a tray-like platform upon which the receiving bags can be supported.

3. Apparatus according to claim 2 wherein the platform is divided into compartments, each compartment being adapted to take one or more receiving bags so that leakage or spillage occurring in one compartment will not contaminate a bag or bags in other compartments.

4. Apparatus according to any preceding claim wherein:
said support means and said actuator means are mounted on a wheeled base so that the apparatus can be wheeled into a location or locations convenient for loading, timed filtration and unloading, and
re-chargeable energy storage means is supported by said base and connected to said actuator means via control means so that the apparatus can operated as a portable self-contained unit.

5. Apparatus according to any preceding claim wherein:
said actuator means comprises at least one vertically extending linear actuator supported by said base and arranged centrally thereof.

6. Apparatus according to any preceding claim wherein:
said second support means comprises two C-shape sub-trays that combine to form an annulus adapted to support the receiving bags,
said annulus defines a central space that surrounds said actuator means,
said C-shape sub-trays are separately detachable so that either or both can be removed for cleaning.

7. Apparatus according to any one of claims 4-6 wherein:
said actuator means comprises a first vertically-disposed gas-operated ram for raising and lowering said first support means and a second vertically disposed gas-operated ram for raising and lowering said second support means,
said energy storage means comprises a gas reservoir adapted to hold pressurized gas for driving said rams, and
said control means comprises gas flow valves and/or pressure regulator means for regulating the flow of pressurized gas from said reservoir to and from said rams.

8. Apparatus according to claim any one of claims 4-6 wherein:
said support means are guided for vertical movement by a pair of vertical posts,
said actuator means includes a first vertically-disposed gas-operated ram located between said posts and connected to one of said support means for raising and lowering said one support means,
said actuator mean comprises a second vertically disposed gas-operated ram connected to the other of said support means for raising and lowering said other support means, said second ram being located within one of said posts and being of the rod-less piston type having an actuator pin that extends transversely from the side of the moving element to engage said other support means.

9. Apparatus according to any preceding claim wherein:
holding means are provided for holding either or both of said support means in the raised position so as to prevent the inadvertent lowering of the support means under control or under gravity.

10. Apparatus according to any preceding claim wherein:
an indicator to display is provided and adapted to indicate the vertical distance or head between the first and second support means

11. A method of handling sealed blood packs after blood collection, each pack including at least a first bag containing blood, a second bag for receiving blood, a tube interconnecting said bags and a filter arranged or connected in the tube so that blood flowing in the tube from the blood containing bag to the blood receiving bag passes through the filter, the method comprising the steps of:
suspending the blood containing bags of a plurality of packs from a rack so that their tubes hang down therefrom,
supporting the blood receiving bags of said packs below their respective blood containing bags,
lowering the platform and the blood receiving bags supported thereon, and
raising the rack and the blood containing bags suspended therefrom.

12. A method according to claim 11 including at least one of the following additional steps:
enabling blood to flow through the tube after the blood-containing bags have been suspended,
raising the platform after blood has been transferred to the receiving bags,
manipulating the receiving bags to release gas therefrom,
sealing the tube of each pack between the filter and the receiving bag,
severing the tube,
removing the receiving bags from the platform,
lowering the rack, and
removing the first bags, filters and remaining tubes from the rack.
